(19) United States
(12) Patent Application Publication
(10) Pub. No.: US 2009/0040220 A1
(43) Pub. Date: Feb. 12, 2009

(54) Hybrid volume rendering in computer implemented animation

(76) Inventors: Jonathan Gibbs, Belmont, CA (US); Jonathan Dinerstein, Draper, UT (US)

Correspondence Address: MORRISON & FOERSTER LLP, 755 PAGE MILL RD, PALO ALTO, CA, 94304-1018, US

(21) Appl. No.: 12/012,626

(22) Filed: Feb. 1, 2008

Related U.S. Application Data
(60) Provisional application No. 60/899,676, filed on Feb. 5, 2007.
(60) Provisional application No. 60/900,570, filed on Feb. 8, 2007.

(51) Int. Cl. G06T 15/00

(52) U.S. Cl. 345/424

(57) ABSTRACT

In the field of computer graphics and more specifically computer implemented animation, two known alternative methods for rendering objects which have volume (fire, smoke, clouds, etc.) are ray marching and splatting (i.e. particle-based rendering). These methods have contrasting strengths and weaknesses. The present volume rendering method and associated apparatus combine these methods, drawing on the strengths of each. The ray marches a volume but, rather than merely accumulating the samples along the ray, a distinct particle is generated for each sample. Each particle captures the volume's local attributes. The particles are then rendered through splatting. Thus the method has the strengths of splatting e.g., fast 3D motion blur and hardware rendering, and the strengths of ray marching e.g., volume sampling density corresponds with camera proximity since rays disperse, thereby focusing computer processing time on important volume detail and minimizing noise. The present method is useful in production of animated feature films, providing fast high-quality volume rendering with true 3D motion blur.

### CROSS-REFERENCE TO RELATED APPLICATIONS

This application claims priority to U.S. Provisional Application No. 60/899,676, filed Feb. 5, 2007, and U.S. Provisional Application No. 60/900,570, filed Feb. 8, 2007, both incorporated herein by reference in their entirety.

### FIELD OF THE INVENTION

This invention generally relates to computer graphics and animation such as used in films, videos, and games, and which is typically computer implemented, and more specifically to the problem in animation of volume rendering, that is depicting volumetric effects.

### BACKGROUND OF THE INVENTION

Volume rendering is a technique used to display a two dimensional projection of a three-dimensional discretely sampled data set, in computer graphics. Usually the data is acquired in a regular pattern, with each volume picture element (voxel) represented by a single value. One must define a camera location in space relative to the volume. A direct volume renderer requires every data sample to be mapped to opacity and a color. Known rendering techniques include ray casting, splatting, shear warp, and texture mapping.

Volumetric effects (e.g., dust, fire, etc) are common in computer-implemented animation. These effects typically employ a physical or procedural simulator (to generate the effect) and a volume renderer. Volume rendering is also useful in medical imaging, where 3D scans of biological tissue are common. The two most popular computer-based approaches to volume rendering are splatting and ray marching. In splatting, the color and opacity of the volume is computed at discrete points. This can be done by sampling a voxel grid (optionally with interpolation), or by directly using particles as the volume representation. Every volume element is “splatted” on to the viewing surface in back to front order. These points are then typically rendered as overlapping circles (disks) with Gaussian falloff of opacity at their edges. Rendering hardware (processors) may be used to accelerate splatting.

In ray marching, rays are cast through the image plane into the volume. Opacity and color are then calculated at discrete locations along each ray and summed into the associated pixel (picture element). In ray casting, the image is projected by casting (light) rays through the volume. The ray starts at the center of the projection of the camera and passes through the image pixel on the imaginary image plane in between the camera and the volume to be rendered. The ray is sampled at regular intervals throughout the volume. Ray marching can be slow, but many optimization schemes have been developed, including faster grid interpolation and skipping of empty space.

### SUMMARY

In accordance with this disclosure, a combination of splatting and ray marching is used, in order to employ the strength of each for computer implemented animation for games, video, feature films, medical imaging, etc. This is perhaps up to an order of magnitude faster in terms of computer processing than is conventional ray marching with motion blur, with results of comparable quality. Ray marching typically samples the volume to be depicted in a pixel-ray-based manner. Thus the sample density corresponds to camera proximity. Ray marching focuses on the volume detail closest to the camera and thus captures the most important detail. In contrast, splatting uses a regular or stochastic sampling of the entire volume. Ray marching often produces higher quality renders and may be faster if splatting densely samples the volume.

The present combination of these is a rendering method and associated apparatus. In accordance with the method, the voxel grid is ray marched with a particle generated for each sample. The particles are then rendered by splatting. For each pixel, a single ray is cast from the camera location through the center of that pixel. Next, one marches along that ray from one point to another point in space. A particle is generated at each step along the ray. This is done using interpolation. That is, for instance 8 equally spaced point values are typically interpolated at a minimum (tri-linear) interpolation or as many as 64 point values for tri-cubic interpolation (see below). The particles represent contributions to individual pixels. Each pixel is rendered as a pixel-size square or using a splat primitive such as a Gaussian disk. The particles can either be rendered one at a time as they are generated during ray marching or alternatively can be rendered in a batch. Motion blur is rendered by splatting the particle multiple times over the velocity vector.

This process has generally been found to be very useful for depicting volumetric visual effects such as fire, dust and smoke. The image quality provided is very high.

Typically this process is carried out via computer software (code) executed on a conventional computer such as a workstation type computer as used in the computer animation field. This process thereby is embodied in a computer program. Coding such a computer program in light of this disclosure would be routine. Any suitable programming language may be used. Some aspects of the process may be embodied in computer hardware.

“Voxel” is a combination of the words volumetric and pixel and is well known in the animation field as referring to a volume element representing a value on a regular grid in 3-dimensional space. It is analogous to a pixel which represents 2-dimensional image data. In the computer animation field, rendering is a process of generating an image from a model by means of computer programs. The models are descriptions of 3-dimensional objects in a defined language or data structure. A model typically contains geometry, viewpoint, texture, lighting and shading information. The image is typically a digital image or raster graphics image. Rendering is typically the last major step in assembling an animation film or video, giving the final appearance to the models and animation. It is used, for instance, in video games, simulators, movie and television special effects.

The present method is directed to a combination of two popular volume rendering schemes. This is appealing because existing knowledge of and systems for volume rendering can be leveraged in implementing and utilizing this technique. The method can be implemented employing a conventional ray marcher and particle renderer. The method executes quickly while producing high-quality images. Ray-based sampling requires fewer samples than traditional splatting for high-quality rendering because ray marching focuses on the nearest (and likely most important) detail. The present method generates and splats particles because it has empirically proven to be a very fast and effective mechanism for motion blur and depth of field. (Depth of field refers to the focus of objects in a scene at various depths.) A single ray per pixel is sufficient, due to the use of motion blur and particles with diameter greater than one pixel.

Strengths of the present method include generality, fast rendering, high image quality, accurate 3D motion blur, depth of field, ease of implementation, adaptive volume sampling density according to camera proximity since rays disperse, and the option to utilize rendering “hardware” (a special purpose computer graphics card) for splatting. The method can also be applied to volumetric effects that are represented by particles rather than a voxel grid. Also provided is a software tool that conventionally generates a voxel grid by projecting the particles into the voxel grid. This is useful since volume renders tend to be richer (providing a better quality image) than are direct particle renders with Gaussian splats.

### BRIEF DESCRIPTION OF THE DRAWINGS

FIGS. 1a and 1b show a comparison of voxel grid sampling, showing in FIG. 1a splatting and in FIG. 1b ray marching. As shown, the sampling is uniform or stochastic in the splatting, whereas the ray marching samples along diverging rays.

FIG. 2a shows how a particle, currently at position p with velocity v, moves towards position p′ in the next frame, and FIG. 2b shows motion blur is rendered by splatting the particle multiple times over the velocity vector, where the total opacity equals the opacity of the original particle.

FIGS. 3a and 3b show fire rendered with conventional ray marching (and no motion blur), and FIGS. 3c and 3d show fire rendered through the present method, complete with fast 3D motion blur.

FIGS. 4a and 4b show large-scale fire effects with volumetric smoke.

FIG. 5 shows volumetric clouds.

FIGS. 6a and 6b show a torch.

FIGS. 7 and 8 show images rendered using the present method.

FIG. 9 shows an apparatus for carrying out the present method.

### DETAILED DESCRIPTION

Splatting and ray marching, as known in the field, have contrasting strengths and weaknesses, as summarized here:

| | Strengths | Weaknesses |
|---|---|---|
| Splatting | Fast motion blur. | Lower quality rendering. |
| | Fast rendering. | |
| Ray marching | Proximity-based sampling. | Slow motion blur. |
| | High quality rendering. | |

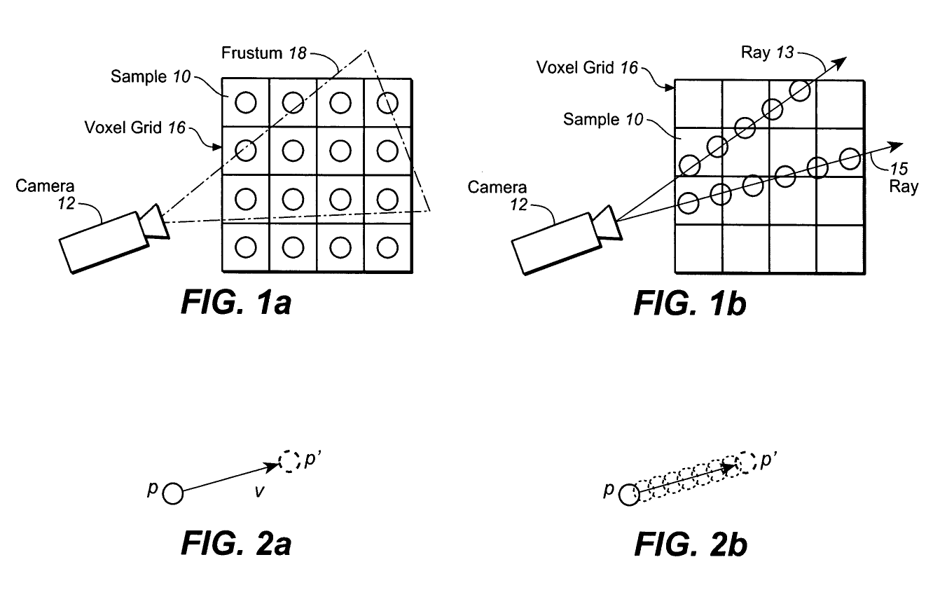

Ray marching samples the volume in a pixel-ray-based manner (see FIG. 1b). Thus the sample 10 density corresponds to camera 12 proximity defined by rays 13, 15. Ray marching naturally focuses on the volume detail that is the closest to the camera and thus likely the most important detail. In contrast, splatting (see FIG. 1a) utilizes a regular or stochastic sampling of the entire volume. The voxel grid 16 (in two dimensions) is shown, the camera observing frustum 18 for splatting. As a result, ray marching often produces higher-quality renders, and may be faster if splatting densely samples the volume. However, splatting is very fast if the volume is sparsely sampled but is then prone to lack of detail and noise.

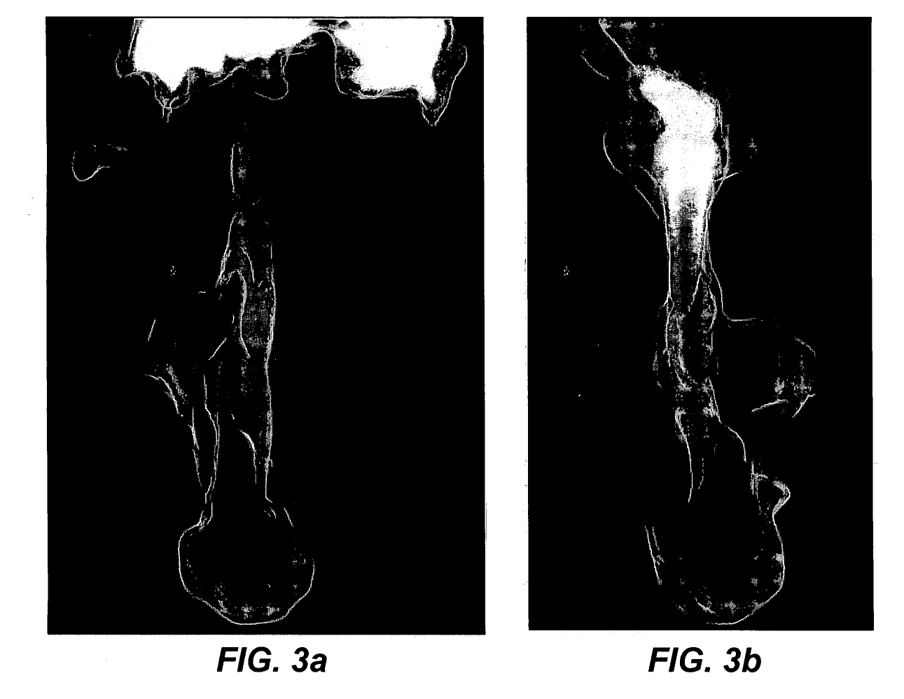

Another distinction between these volume rendering methods is motion blur. Note that providing motion blur is challenging in volume rendering, because correct blur requires that the velocity within the volume be taken into account. For example, a stationary volume may internally represent a turbulent fluid. This motion will only be blurred if internal velocity is considered. Fortunately it is simple to achieve accurate 3D motion blur in splatting (see FIGS. 2a, 2b). This is done by associating with each particle p the velocity v at that point inside the volume then draw each particle multiple times per animation frame (see FIG. 2b), distributed along its velocity vector v defined by p, p−. In contrast, motion blur with ray marching is notoriously slow to compute (using rays distributed through time) and thus rarely done. This is unfortunate because motion blur is an important component of temporal antialiasing. Many volumetric effects have high velocity (e.g., fire) and thus undesirable strobing can result if no blur is present. Given the contrasting strengths and weaknesses of existing techniques, volume rendering has often seemed a “black art”. The present volume rendering method combines ray marching and splatting, leveraging the strengths of each.

This disclosure is directed to such a hybrid volume rendering method combining ray marching and splatting, retaining many of their unique strengths. The method includes:
1. The voxel grid is ray marched, with a particle generated for each sample.
2. The particles are rendered through splatting.

In the ray marching, for each pixel P, a single ray R is cast from the (notional) camera position C through the center of the pixel where R.o is the ray origin and R.d is the ray direction:

R.\vec{o}=C.position, R.\vec{d}=unit(P.center−C.position), R(t)=R.\vec{o}+R.\vec{d}·t, (1)

where t is a parameter along the ray. This ray is intersected with the voxel grid bounding box to determine the entry and exit points, at locations t₀ and t₁ respectively. To simplify intersection and marching, one applies the inverse grid transformation to the ray.

Next one marches along the ray from t₀ to t₁. Specifically, increment t=t+Δt where Δt is a constant that may be set by the user. One can set Δt such that about 150 steps (increments) are taken along rays that directly penetrate the volume.

A particle is generated at each step along the ray. The particle inherits the interpolated attributes (position, color, opacity, and velocity) of the voxel grid defined at that exact point R(t) in the voxel grid. One may utilize a choice of fast tri-linear (linear in dimensions X, Y, Z), tri-quadratic, or tri-cubic interpolation between voxels. The interpolation order is selected by the user (animator) per grid attributes. While non-linear interpolation is notably more computationally expensive than simple linear interpolation, higher order interpolation helps achieve sufficient visual quality for feature film production. This is especially true of velocity since it controls motion blur.

The present non-linear interpolation is based on the unique quadratic/cubic polynomial that interpolates three or four equally-spaced values. The polynomial equation may be derived through matrix inversion. The quadratic and cubic equations are reasonably simple and fast to execute on a computer processor. As an example, a quadratic interpolation f is:

ƒ(p)=d[0]+p*((2−p)*d[2])*d[0]+(1−p)*d[2])*0.5) (2)

where p is the position of the particle and d[ ] is the equally-spaced data to interpolate. The interpolation is executed in three passes, in dimensions xyz order for those 3 dimensions in space. Thus this equation is evaluated 13 times for each grid attribute to interpolate: 9 times in x, 3 times in y, and 1 time in z.

Nearly all computer processing time in the present method is spent in interpolation since particle splatting is so fast computationally. To minimize grid sampling, one can use two simple optimizations. First, precompute those voxel neighborhoods that have (nearly) zero opacity and skip over them. Second, terminate the ray if full opacity has been reached. The present method provides high-quality renders with only one ray per pixel, which helps keep the number of grid samples down.

In splatting, the particles represent contributions to individual pixels. As such, it is possible to render them by merely adding them to the associated pixels. However, this simple method may not be sufficient since the particles will move to non-pixel-center locations during motion blur. However, the method does not need elaborate splatting (e.g., Gaussian disks).

Each particle is rendered as a pixel-sized square or rectangle. Its contribution to a given pixel is modulated by the fraction of the pixel the particle covers. This weight w is easy to compute by this equation:

w(l,p)=max(1−abs(l,x−p,x))*max(1−abs(l:y−p.y)), (3)

where p is the position of the particle and l the center of the pixel, and assuming the pixel extends over a unit range in dimensions x and y. Alternatively, particle rendering can be performed on conventional rendering hardware (processors) using simple primitives. Note that particle diameter can be increased to achieve fast and easy noise filtering such as Gaussian disks.

The particles can either be rendered one at a time as they are generated during ray marching, or alternatively can be rendered in batch. Immediate rendering is preferable as less computer memory is utilized. However, ordered rendering (e.g., back-to-front) is useful in some circumstances and requires batch rendering. Fortunately, the particles are very “light” (requiring little memory)—one example successfully uses up to 35 million particles per frame. The order of particles along each ray can be utilized to speed up sorting.

Motion blur is rendered by splatting the particle multiple times over the velocity vector, where the total opacity equals the opacity of the original particle (see FIGS. 2a, 2b). This is achieved by projecting the velocity vector into the image plane. If the particles are being rendered in an ordered fashion, the order is assumed to remain consistent while blurring.

Illumination of hazy volume media is difficult to compute since incoming light is attenuated by partially opaque regions of the volume. Self-shadowing may be computed by shooting shadow rays and integrating attenuation, but this is slow to process. There is a known technique known as “light volume” for reusing illumination calculations. Specifically, illumination is computed for the center point of each voxel. Illumination at an arbitrary point in the volume is then approximated through interpolation. This can speed up rendering when multiple samples are taken per voxel.

However, light volumes have limitations. First, there is no speed/quality tradeoff that can be adjusted by the animator since the illumination information is always the same resolution as the voxel grid. Second, there may be no clear way to store in memory the light volume for certain volume representations, such as spheres filled with noise (a pseudo-random pattern which gives the appearance of a natural texture. An example of such noise is called “Perlin Noise” in the field.). Third, the illumination of every voxel is computed before rendering. This is computationally wasteful since portions of the volume may not be rendered due to 0 opacity or lying outside the camera frustum.

The present approach therefore utilizes a modified form of the light volume technique. The present approach provides a speed/quality tradeoff adjustable by the animator that works with any volume representation and only computes lighting in necessary regions of the volume.

This is done by decoupling the light volume from the voxel grid. Specifically one creates a distinct voxel grid (herein after referred to as the “light grid”) whose resolution is specified by the animator. Upon creation, the light grid is aligned and oriented with the volume data bounding box. (A bounding box is a representation of the extent of the volume.) In other words, the light grid precisely fits the volume data whatever the volume data representation may be. The light grid is initialized in order to contain no illumination information. One also allocates an array of binary flags (indicators), one flag per voxel, which denote whether illumination in the voxel's entire neighborhood has been computed. (The neighborhood is defined by the surrounding points used for the interpolation. For a tri-linear interpolation it is the 8 points defining the voxel edges.) This is useful for quickly determining if light voxels need to be illuminated. The neighboring block is the same width as the grid interpolation filter which is the mechanism of the interpolation used to define the volume attributes at any point in space. The grid illuminations is computed and stored on demand. Then illumination at the sample point p is quickly approximated through grid interpolation.

In feature film production, any given frame is rendered many times during the animation process. Thus it is useful to provide animators with software tools that provide both fast/lower quality renders and slow/high quality renders, in other words a tradeoff between speed and quality. The choice of light grid resolution provides the animator with a simple approach to adjust speed/quality. The animator may also be provided with a choice of tri-linear, tri-quadratic and tri-cubic interpolation for the light grid, as explained above. The calculation of light grid illumination on demand speeds up rendering overall since there is no wasted computation.

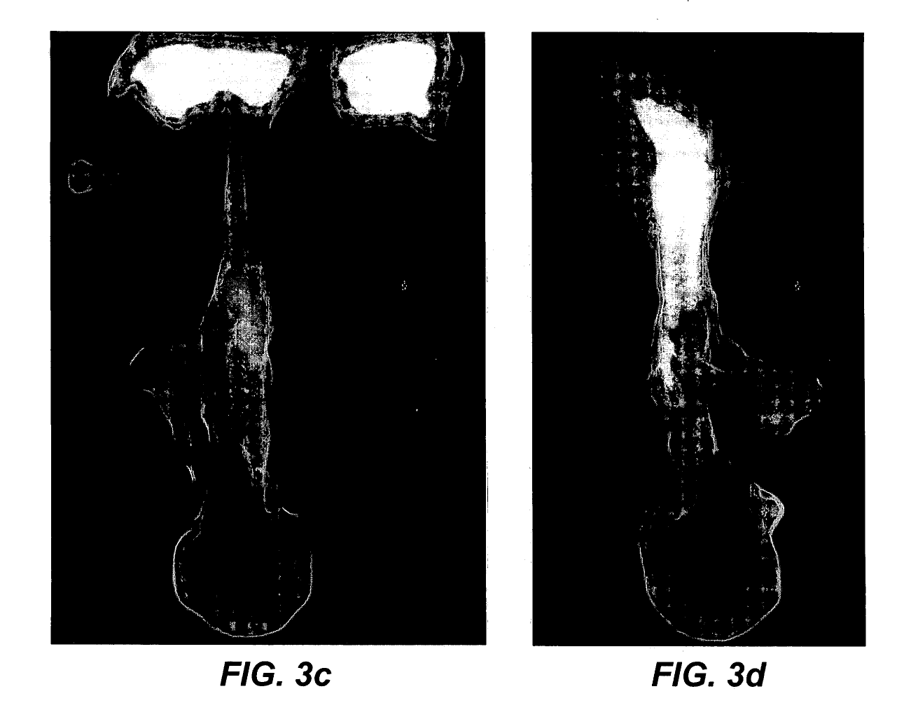

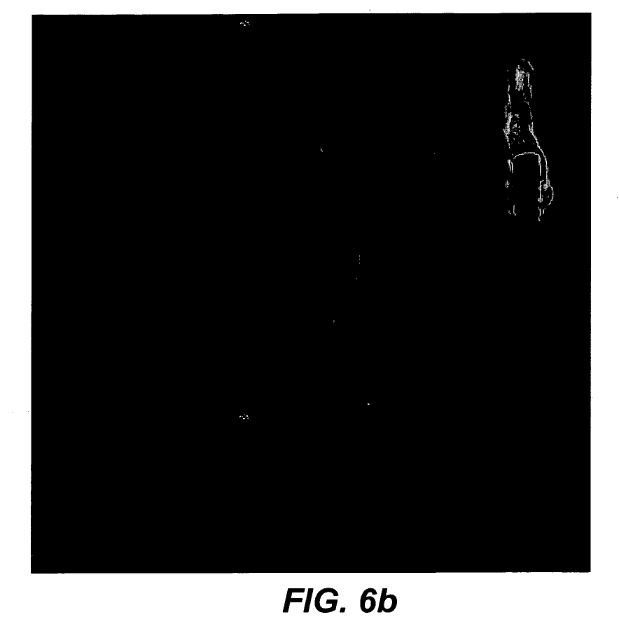

The present methods can be used for volumetric visual effects in feature animated films. These effects include fire, dust, and smoke, Examples of such effects are shown in FIGS. 3-8. Either a conventional Navier-Stokes fluid simulator (software module) or a conventional procedural system was used conventionally to generate each illustrated image. The procedural system writes volume data files to computer memory to be accessed by the renderer. Typically there is one volume file per animated frame.

As can be seen in these examples, the image quality is very high. All of these exemplary images were rendered with only one ray per pixel, and approximately 150 samples (increments) per ray. This technique is very fast—on a 3 GHz speed computer processor, rendering an HDTV (high definition television)—resolution image of motion-blurred fire takes approximately one minute per frame of the image. Also, the technique utilizes little computer memory if the particles are rendered when they are generated rather than being buffered and rendered in batch.

The importance and effectiveness of motion blur is demonstrated in FIGS. 3a, 3b, 3c and 3d. The two images without motion blur in FIGS. 3a and 3b undesirably appear very synthetic, more like a lava lamp than actual fire. In contrast, the two motion blurred images in FIGS. 3c and 3d appear significantly more realistic.

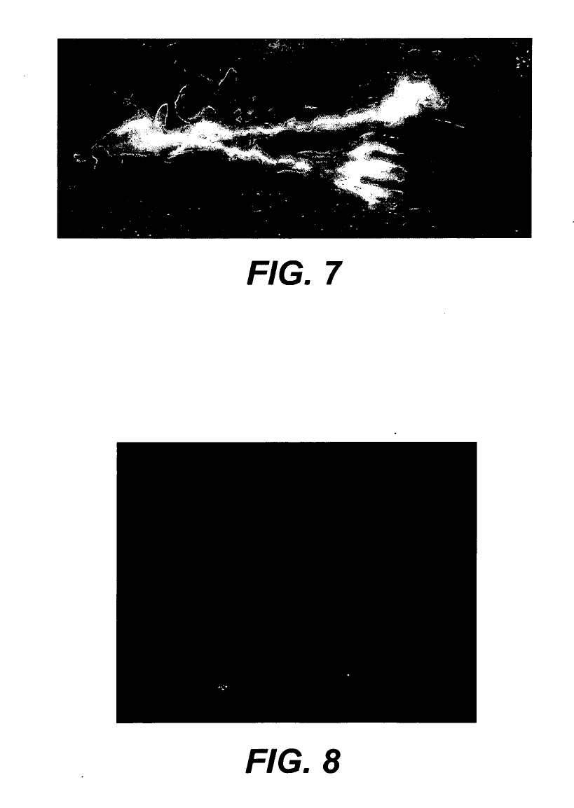

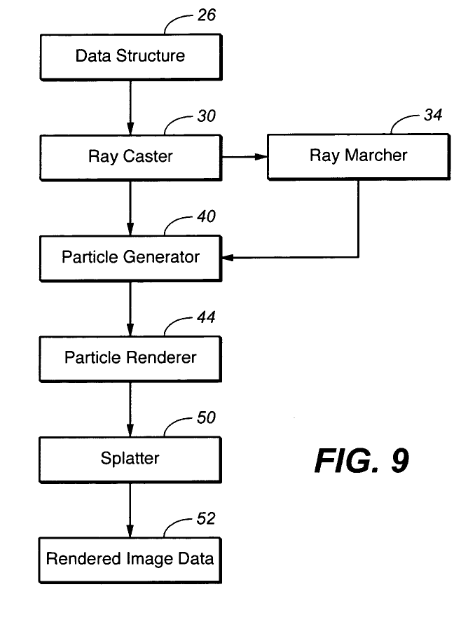

In one example, one uses a default light grid size of 175³ which requires approximately 61.3 MB of memory. This memory requirement is further reduced if the volume is rectangular (not cubic), such as 100×174×100. This relatively small size has empirically been determined to be effective for producing renders virtually indistinguishable from renders produced using exhaustive shadow rays. Exemplary images produced using this technique are shown in FIG. 8, showing a visual effect rendered with the present method and in FIG. 9 similarly a volumetric cloud with self-shadowing.

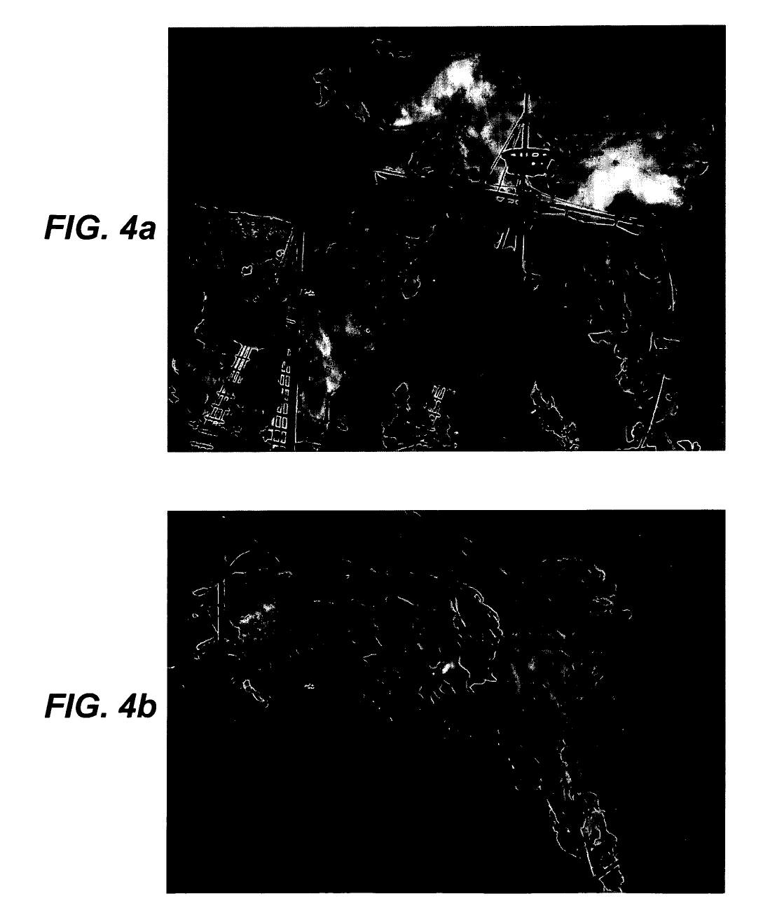

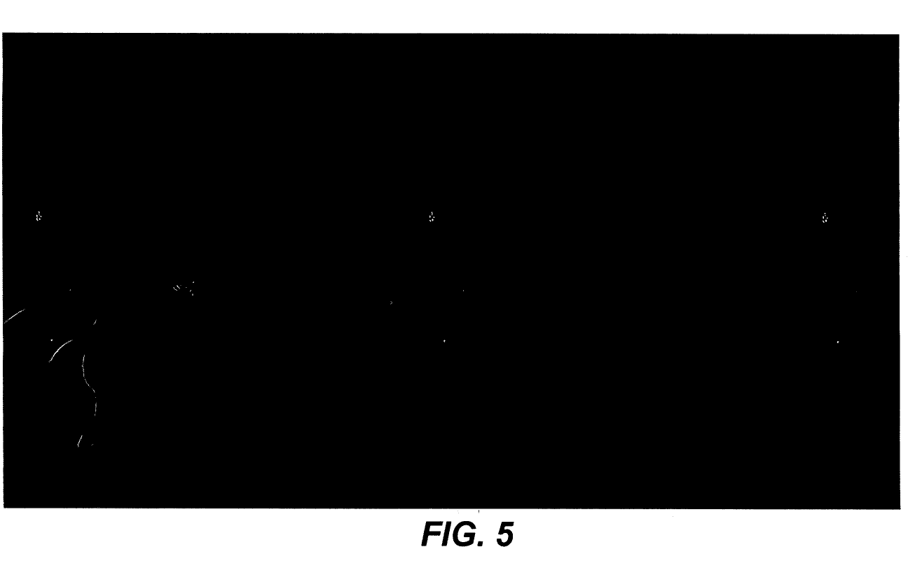

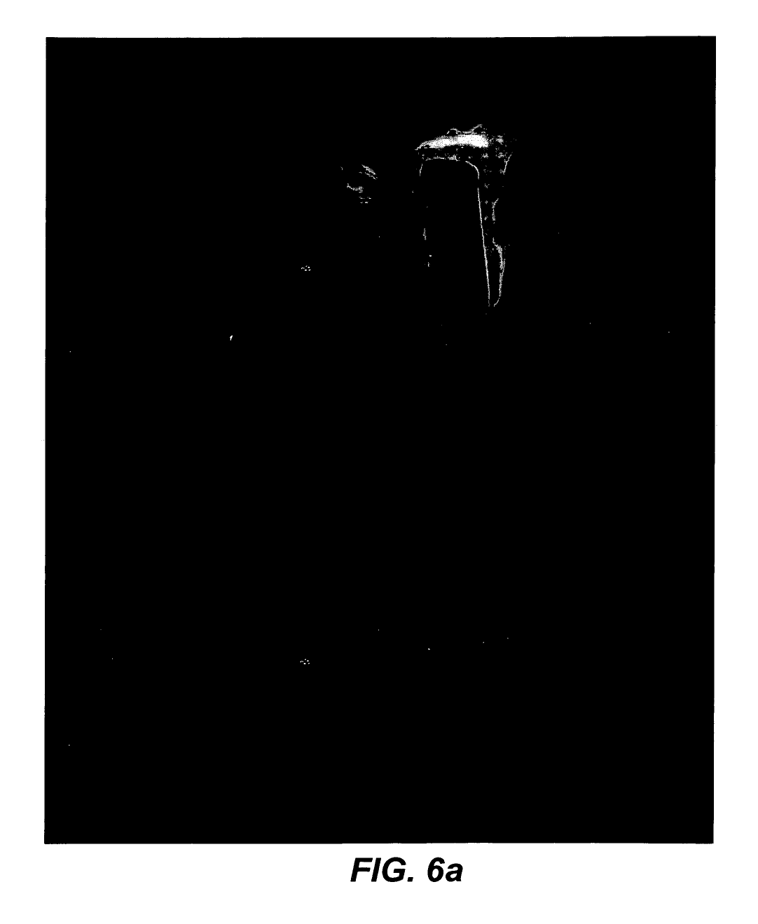

Further examples show the effectiveness of the present method for a wide variety of volumetric media. For example, it depicts highly transparent and incandescent fluids such as fire, and thick smoke with self-shadowing. Thus FIGS. 4a and 4b show two examples of large scale fire effects with volumetric smoke using the present method. FIG. 5 shows volumetric clouds. FIGS. 6a and 6b show two examples of a torch.

There is a visual limitation of the motion blur produced by this technique. This is very slightly visible in FIGS. 3c and 3d. In a region of the volume where motion vectors diverge, the associated particles diverge when rendering motion blur through splatting. As a result, the motion blur can undesirably appear hair-like. However, in practice, this artifact only appears in extreme conditions, and is minimal.

FIG. 9 shows an apparatus in the form of a computer program partitioned into elements to carry out the present method. Note that the depiction of FIG. 9 is merely illustrative; other variations are also within the scope of the invention. In FIG. 9, data structure 26 (to be stored in a suitable computer memory) defines a plurality of pixels which represent the image to be depicted. A ray caster element or code module 30 performs the ray casting. Next, a ray marcher element or code module 34 does the ray marching, at the predefined increments. The particle generator element or code module 40 generates the particles for each ray at each increment. The particles are then rendered by particle renderer element or code module 44. The splatterer element or code module 50 then splats the particles and the resulting rendered image data 52 is stored in memory. Note that the designations and organization of these elements are only illustrative, and further some of the elements, or portions of them, may conventionally be embodied in hardware such as a dedicated processor and/or logic, rather than in software.

This disclosure is illustrative and not limiting; further modifications will be apparent to one skilled in the art in light of this disclosure and are intended to fall within the scope of the appended claims.

What is claimed as new and desired to be protected by Letters Patent of the United States is:

1. A computer implemented method for depicting a volumetric effect occupying a volume, comprising the acts of:
providing a plurality of picture elements to define an image of the volumetric effect;
for each picture element casting a ray from an observation location through each picture element;
moving through the volume along each ray in increments;
at each increment, generating a particle;
rendering the particles; and
splatting each particle multiple times to define the image of the volumetric effect.

2. The method of claim 1, wherein the act of generating a particle includes interpolating.

3. The method of claim 2, wherein the interpolating is non-linear.

4. The method of claim 2 wherein the interpolating includes applying one of a tri-linear, tri-quadratic, and tri-cubic interpolation.

5. The method of claim 1, wherein the rendering of the particles is individually or in batches.

6. The method of claim 1, wherein each particle is rendered on a quadrilateral the size of one of the picture elements.

7. The method of claim 1, wherein each particle has the attributes of position, color, opacity, and velocity.

8. The method of claim 1, wherein the observation location is that of a notional camera recording the image.

9. The method of claim 1, wherein the act of casting the ray includes for each ray:
determining its entry and exit point for the volume; and
applying an inverse transformation to the ray.

10. The method of claim 1, wherein the number of increments for each ray is in the range of 50 to 450.

11. The method of claim 1, wherein the act of splatting includes:
weighting each particle by a proportion of the associated pixel covered by the splatted particle.

12. The method of claim 1, wherein the act of splatting includes projecting a vector representing the velocity onto a plane defined by the picture elements, thereby to render motion blur.

13. A computer readable medium storing computer code for carrying out the method of claim 1.

14. The method of claim 1, further comprising repeating the act of splatting to provide motion blur.

15. The method of claim 1, further comprising setting a depth of field of the image.

16. Computer implemented apparatus for depicting a volumetric effect occupying a volume, comprising:
a memory storing a plurality of picture elements defining an image;
a ray caster element coupled to the memory and casting a ray for each picture element from an observation location through each picture element;
a ray marcher element coupled to the ray caster and which moves through the volume along each ray in increments;
a particle generator element coupled to the ray marcher and which generates a particle at each increment;
a particle renderer element coupled to the particle generator and which renders the particles; and
a splatterer element coupled to the particle renderer element and which splats each particle multiple times to define the image of the volumetric effect.
